(19) United States
(12) Patent Application Publication
(10) Pub. No.: US 2002/0100376 A1
(43) Pub. Date: Aug. 1, 2002

(54) Electric aluminum can crusher

(76) Inventors: Kevin W. Schell, Dyer, IN (US); Gail A. Schell, Dyer, IN (US)

Correspondence Address: Richard C. Litman, LITMAN LAW OFFICES, LTD, P.O. Box 15035, Arlington, VA, 22215, US

(21) Appl. No.: 09/771,995

(22) Filed: Jan. 30, 2001

(51) Int. Cl. B30B 3/04; B30B 9/32

(52) U.S. Cl. 100/49; 100/155 R; 100/171; 100/172; 100/902

(57) ABSTRACT

The electric aluminum can crusher is an appliance for crushing aluminum beverage cans suitable for use in households and commercial establishments. The crusher has an electric motor rotating a first crusher wheel and a second crusher wheel mounted on a spring biased support arm via a chain drive. Aluminum cans are inserted into a feeder chute having a discharge opening adjacent the junction of the crusher wheels. The feeder chute has a sensor, preferably an electric eye disposed on an interior wall of the chute, which detects the passage of a can through the chute and turns the electric motor on for a timed interval. As a can exits the feeder chute it is crushed between the crusher wheels and is discharged from the crusher. A pair of guides retain the can between the crusher wheels. The support arm may be retracted to clear any jam between the roller wheels.

### BACKGROUND OF THE INVENTION

1. Field of the Invention

The present invention relates to commercial and household appliances, and particularly to an electric aluminum can crusher for crushing cans for recycling.

2. Description of the Related Art

Concern for the environment and conservation of our national resources has led to the adoption of various measures for recycling waste products by many state, county and municipal authorities, including measures for the recycling of aluminum cans of the type which are used to package beverages, including soft drinks, beer, etc. Recycling typically involves the pickup of used aluminum cans from residences and commercial facilities by sanitation trucks for transport to recycling facilities. In order to reduce the bulk of such waste containers, it is advantageous to crush the cans so that the volume of waste material is more compact. Several devices for crushing aluminum cans have been developed for use by households and commercial establishments.

Can crushing devices which utilize a piston or ram driven in a cylinder by an electric motor are described in several patents, including: U.S. Pat. No. 5,103,721, issued Apr. 14, 1992 to Chou, et al. (vertical crushing chamber with a moveable floor driven by an electric motor via a bell crank assembly and gearing); U.S. Pat. No. 5,188,022, issued Mar. 23, 1993 to Benson, et al. (crusher with compression plate driven by electric motor through rack and pinion mechanism for smoother application of force); U.S. Pat. No. 5,417,154, issued May 23, 1995 to F. V. Ploats (table mounted crusher with electric motor driving a ram in a cylinder equipped, the crusher equipped with a ramped can feeder); U.S. Pat. No. 5,456,166, issued Oct. 10, 1995 to Belongia, et al. (crusher with a ram driven by an electric motor, featuring an nonlinear feed and discharge chutes for safety purposes); U.S. Pat. No. 5,819,644, issued Oct. 13, 1998 to M. A. Coffelt (can crusher with electric motor driving a ram, the mechanism including rotating and reciprocating levers); U.S. Pat. No. 5,829,348, issued Nov. 3, 1998 to R. E. Morgan (crusher with ram driven by electric motor, including a discharge chute and container for receiving crushed cans); and Japanese Patent No. 62-224500, published Oct. 2, 1987 (crusher with electric motor driving ram by means of a screw shaft).

Other mechanisms for powering aluminum can crushers are also known in the art. For example, a hydraulically powered ram is shown in United Kingdom Patent No. 853,315, published Nov. 2, 1960. Mechanical operated can crushers are exemplified by U.S. Pat. No. 4,976,196, issued Dec. 11, 1990 to Phillips, et al. (mechanical crusher for crushing the can from its sidewall) and U.S. Pat. No. 5,009,155, issued Apr. 23, 1991 to K. A. Christianson (can crusher with a wooden ram).

None of the above inventions and patents, taken either singularly or in combination, is seen to describe the instant invention as claimed. Thus an electric aluminum can crusher solving the aforementioned problems is desired.

### SUMMARY OF THE INVENTION

The electric aluminum can crusher is an appliance for crushing aluminum beverage cans suitable for use in households and commercial establishments. The crusher has an electric motor rotating a first crusher wheel and a second crusher wheel mounted on a spring biased support arm via a chain drive. Aluminum cans are inserted into a feeder chute having a discharge opening adjacent the junction of the crusher wheels. The feeder chute has a sensor, preferably an electric eye disposed on an interior wall of the chute, which detects the passage of a can through the chute and turns the electric motor on for a timed interval. As a can exits the feeder chute it is crushed between the crusher wheels and is discharged from the crusher. A pair of guides retain the can between the crusher wheels. The support arm may be retracted to clear any jam between the roller wheels.

Accordingly, it is a principal object of the invention to provide an electric aluminum can crusher for crushing cans for recycling.

It is another object of the invention to provide an electric aluminum can crusher which crushes aluminum cans from the sidewall rather than axially.

It is a further object of the invention to provide an electric aluminum can crusher having a sensor to detect the passage of cans through a feeder chute to automatically start and stop the crusher.

Still another object of the invention is to provide an electric aluminum can crusher which uses roller wheels to crush aluminum cans for recycling.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a perspective view of an electric aluminum can crusher according to the present invention.

FIG. 2 is an elevational view of an electric aluminum can crusher according to the present invention, the housing cover being removed.

FIG. 3 is an elevational view of the electric aluminum can crusher of FIG. 2, the follower arm being elevated.

FIG. 4 is a front view of an electric aluminum can crusher according to the present invention, the housing cover being removed and a portion of the housing being broken away.

FIG. 5 is a diagrammatic view of the chain drive mechanism within the can crusher housing.

FIG. 6 is an elevational view of the interior of the housing cover.

FIG. 7 is a section view through the feeder chute.

Similar reference characters denote corresponding features consistently throughout the attached drawings.

### DETAILED DESCRIPTION OF THE PREFERRED EMBODIMENTS

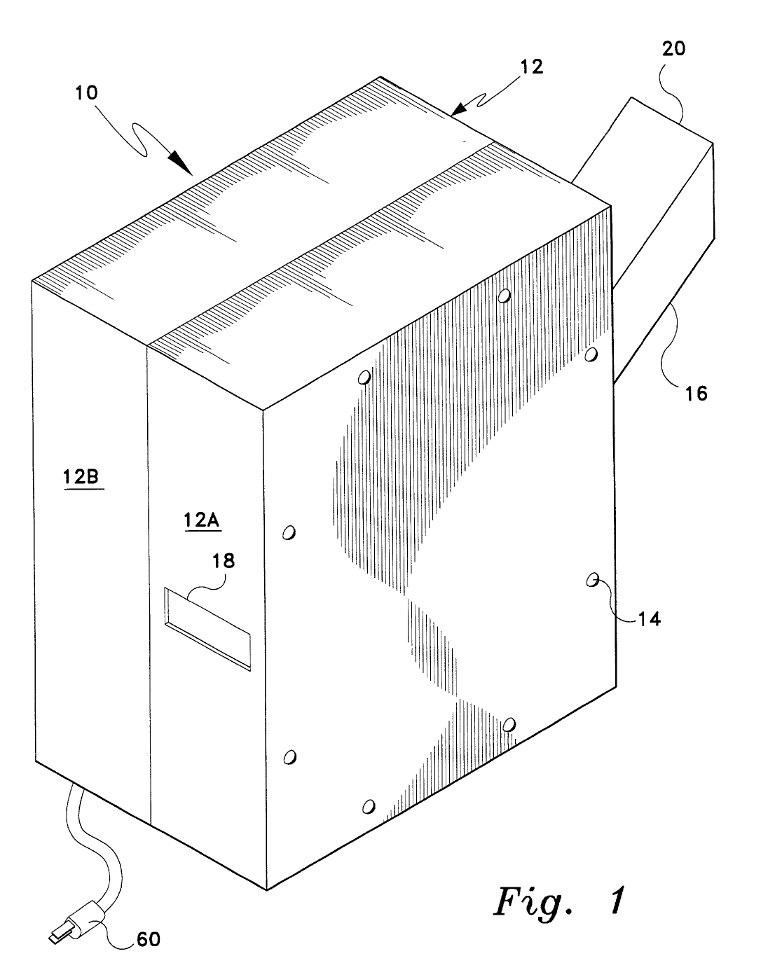

The present invention is an electric aluminum can crusher, designated generally as 10 in the drawings, which show the crusher 10 in schematic form. The can crusher 10 is intended for household use, as well as use in such commercial establishments as bars, restaurants, and the like. Consequently, the crushing mechanism is contained within a housing 12, as shown in FIG. 1, which may include a housing body 12B and a housing cover 12A fastened to the body 12B by screws 14 or other conventional fastening means. A feeder chute 16 extends from the rear side of the housing 12, and the front side of the housing 12 has an opening 18 defined therein through which the cans exit the housing 12 after being crushed. The feeder chute 16 is hollow and tubular, having a first end 20 which extends outside the housing 12 and which is open to receive cans which are to be crushed.

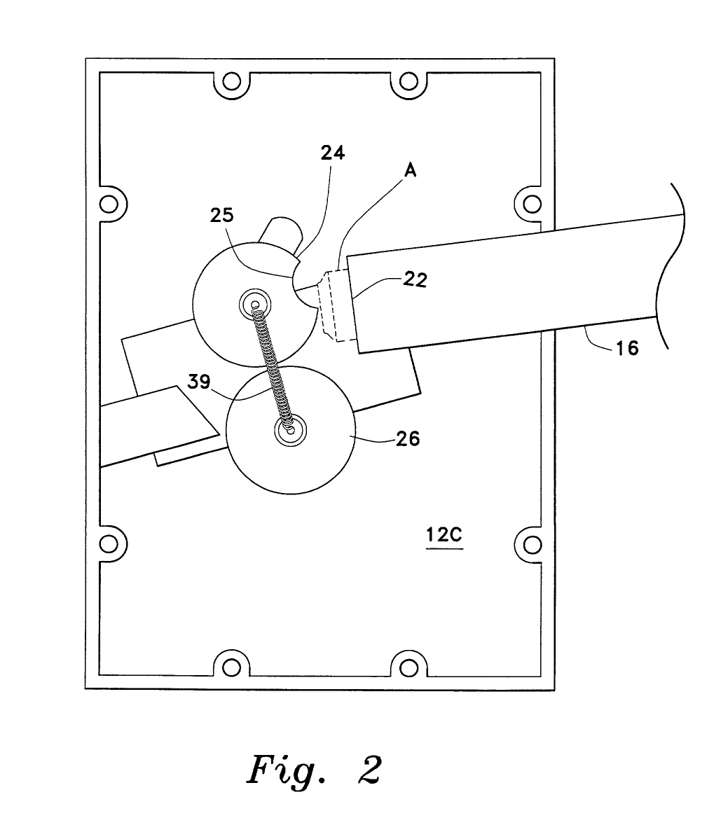

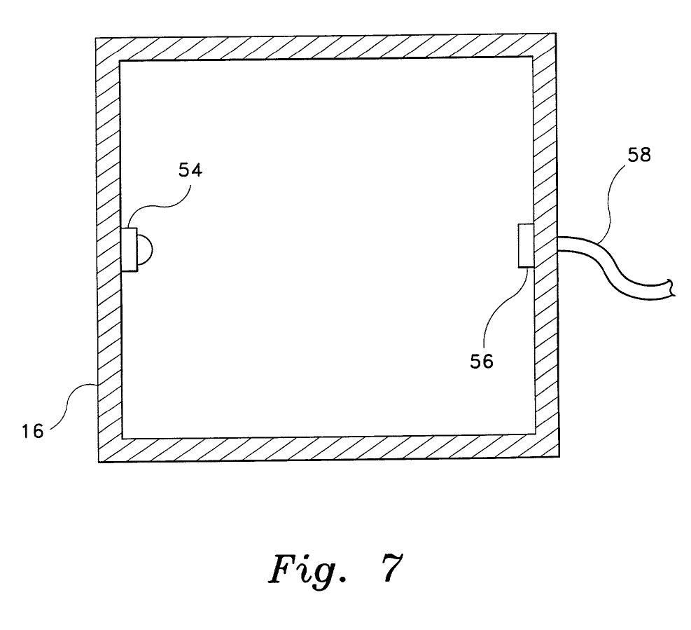

As shown in FIG. 2, the chute 16 has a second end 22 which delivers the can A to a pair of opposed crusher wheels 24 and 26. The feeder chute 16 may be mounted in the housing 12 either in an absolutely vertical position, or with the first end 20 raised higher than the second end 22 so that the chute 16 slopes downward into the housing. In any event, preferably the cans A are fed through chute 16 to the crusher wheels 24 and 26 solely by gravity. As shown in FIG. 7, the chute 16 is preferably rectangular in cross section. Although the chute 16 is shown as a linear tube in the drawings, it will be understood that the feeder chute 16 may be nonlinear, if desired. Representative dimensions of the chute 16 may be 3″×3″×14″.

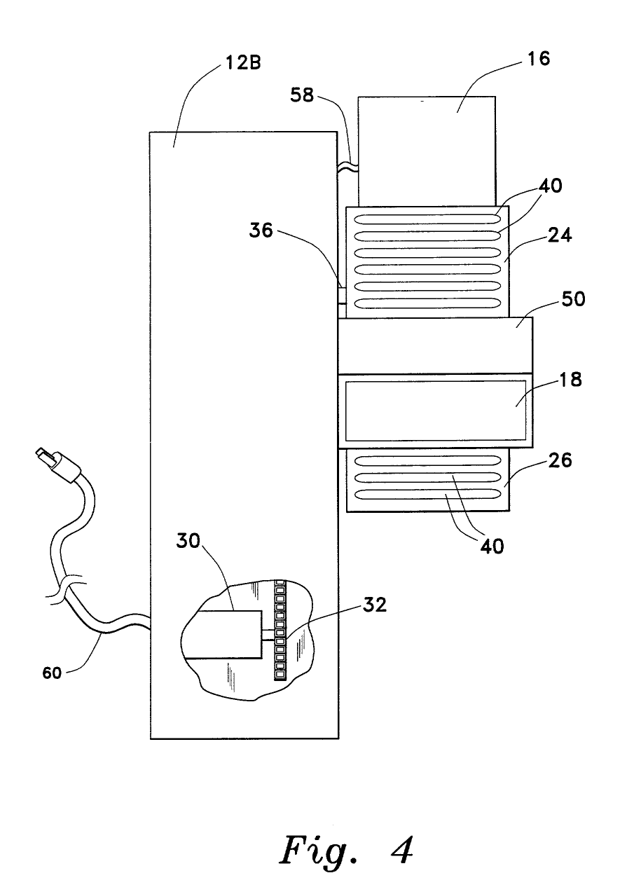

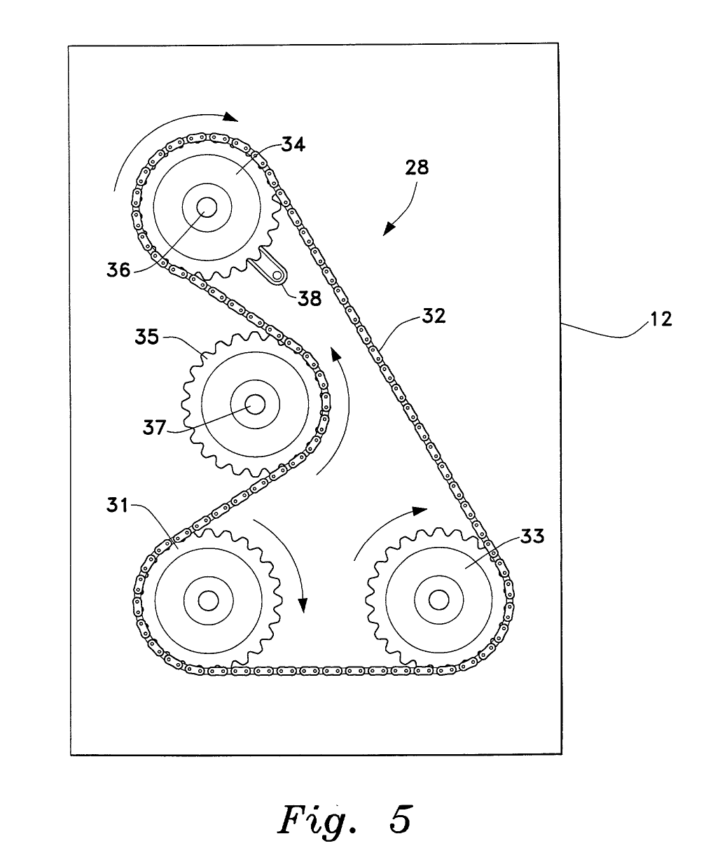

As shown in FIGS. 2-5, the feeder chute 16 delivers the can A to the pair of crusher wheels 24 and 26. Wheels 24 and 26 are driven by a chain drive mechanism 28, shown more particularly in FIGS. 4-5. The chain drive mechanism 28 includes a motor 30 having a drive sprocket wheel 31 mounted on its shaft. An endless loop chain 32, such as a roller chain, connects the drive sprocket wheel 31 to three other sprocket wheels, including tension sprocket wheel 33, first roller sprocket 34, and second roller sprocket 35. Crusher wheel 24 is mounted on the same axle 36 as first roller sprocket 34, and crusher wheel 26 is mounted on the same axle 37 as second roller sprocket 35, so that rotation of the first 34 and second 35 sprocket wheels causes crusher wheels 24 and 26 to rotate in opposite directions, one clockwise and the other counterclockwise. Opposite directions of rotation are obtained by disposing first roller sprocket 34 within the continuous loop defined by chain 32 and second roller sprocket 35 outside the loop, while maintaining support arm 38 under sufficient tension to force the links in chain 32 to engage second roller sprocket 35. The axle 36 is rotatably mounted on support arm 38, which is pivotally mounted to housing 12 so that crusher wheel 24 may be raised to clear any jams which may occur.

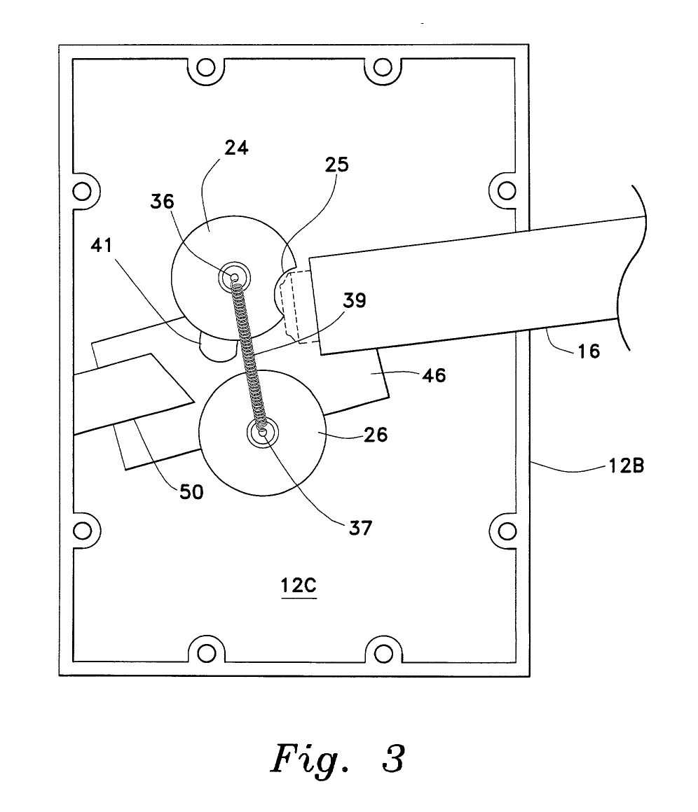

The chain drive mechanism 28 is disposed within housing body 12B. Axles 36 and 37 extend through internal housing wall 12C, the roller sprockets 34 and 35 being disposed on one side of internal housing wall 12C and the crusher wheels 24 and 26 being disposed on the opposite side of internal housing wall 12C. Axle 36 extends through an arcuate slot 41 defined in internal housing wall 12C which defines the range of motion of support arm 38. Bias spring 39 is connected between axles 36 and 37 to normally bias crusher wheels 24 and 26 so that they are closely approximated in a crushing position, as shown in FIG. 2, but permits rotation of support arm 38 upward to clear jams as shown in FIG. 3.

Each of the crusher wheels 24 and 26 is preferably between about four inches and five inches in diameter, and the rim of each wheel 24 and 26 is about three inches wide. The wheels 24 and 26 are preferably made from hard rubber or other material adapted for frictionally engaging the can A. The rim of each wheel 24 and 26 may have a plurality of grooves 40 defined transversely across the rim of the wheel 24 or 26, the grooves 40 being adapted for engaging the lip normally found around the base of a cylindrical aluminum can A at either the top or bottom of the can A, in order to pull the can A between the crusher wheels 24 and 26. Crusher wheel 24 has a notch 25 extending transversely across the rim of wheel 24 for the same purpose, as shown in FIG. 2. As the crusher wheel 24 rotates, for example, in a clockwise direction, the notch 25 in crusher wheel 24 engages a base of the cylindrical can A from one side, while the other side of the same base engages crusher wheel 26, which is rotating in a counterclockwise direction, being driven by chain drive mechanism 28, drawing the can A between the wheels 24 and 26 and crushing the can A.

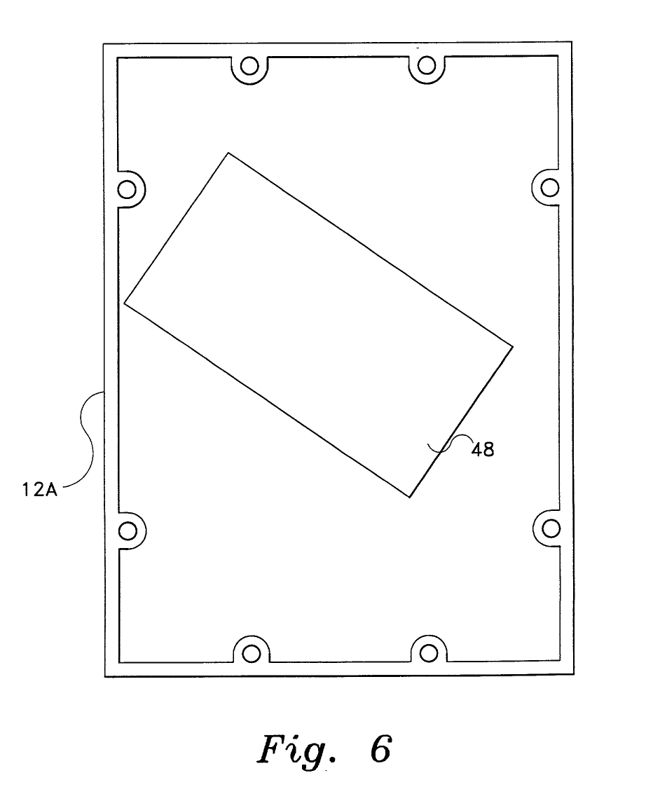

As the can A is drawn between the crusher wheels 24 and 26, the can A is prevented from moving laterally by a pair of retainer walls 46 and 48, including a first wall 46 mounted on the housing body 12B and a second wall 48, seen more particularly in FIG. 6, mounted inside the housing cover 12A. The retainer walls 46 and 48 are disposed on opposite sides of the crusher wheels 24 and 26 and extend parallel to the path of the can A. The can A is flattened along its peripheral wall, in contrast to a ram crusher in which the can is crushed axially in accordion style. The slot 41 is also defined through retainer wall 46 to permit rotation of support arm 38, as described above. As the can A exits the crusher wheels 24 and 26, it drops onto a downward sloping discharge chute 50 and exits the crusher through the opening 18, where it may collected in a box (not shown) or other collection bin or container.

As shown in FIG. 7, the feeder chute 16 has a sensor mechanism disposed on the inside walls of the chute 16. In the preferred embodiment, the sensor mechanism is an optoelectronic device, such as an electric eye comprising an infrared transmitter 54 and receiver 56, which senses the passage of a can through the chute 16. The sensor mechanism is connected by appropriate wiring 58 to timer circuitry (not shown) disposed within the housing body 12B for turning the motor 30 on for a predetermined period adequate to crush the can A, preferably between about five to fifteen seconds. Although the sensor mechanism is preferably an optoelectronic device, it will be obvious that a mechanically triggered electrical switch may be used instead. Timer circuitry for turning the motor 30 on a timed period using Silicon Controlled Rectifiers (SCR), Triacs, and/or integrated circuits such as the 555 timer are well known in the electronics art.

Although the can crusher 10 may be battery powered, in the preferred embodiment the can crusher 10 is equipped with a conventional electrical cord and plug 60 for connection to a standard wall outlet.

In use, the can crusher 10 may be disposed in any convenient location in a household, restaurant, bar, or similar commercial establishment, such as in a cabinet disposed below the sink. The plug 60 is normally left inserted in a wall outlet, so the can crusher 10 is always ready for use. One or more aluminum cans are dropped into the feeder chute 16, falling through the chute 16 by gravity. As the can A travels in the chute 16, the path between the infrared transmitter 54 and receiver 56 is interrupted, causing electric power to be applied to the motor 30, causing the chain drive mechanism 28 to rotate the crusher wheels 24 and 26. When the can A arrives at the gap between the wheels 24 and 26, the can A is drawn between the wheels 24 and 26 by gravitational force, frictional engagement with the rim of the wheels 24 and 26, and engagement of a lip of the can by the notch 25 defined in wheel 24 and the plurality of grooves 40 defined in the rim of the wheels 24 and 26. The retainer walls 46 and 48 maintain the can A between the wheels 24 and 26. After being crushed, the can A is deposited on the discharge chute 50 and exits the housing 12 through the opening 18.

It is to be understood that the present invention is not limited to the embodiments described above, but encompasses any and all embodiments within the scope of the following claims.

We claim:

1. A electric aluminum can crusher comprising:
a) a housing;
b) a chain drive mechanism disposed in said housing;
c) a first crusher wheel mounted on said chain drive mechanism, the crusher wheel having a rim about its circumference;
d) a support arm mounted on said housing;
e) a second crusher wheel rotatably mounted on said support arm and connected to said chain drive mechanism, the second crusher wheel having a rim about its circumference;
f) a feeder chute, the feeder chute being hollow and tubular and having a first end and a second end, the feeder chute being mounted on said housing, the first end of said chute being sized and dimensioned for receiving an aluminum can inserted axially into the feeder chute, the feeder chute sloping downward from the first end to the second end so that an aluminum can falls through said feeder chute by the force of gravity, the second end being disposed adjacent said first and second crusher wheels; and
g) actuator means for applying electrical power to said chain drive mechanism in order to rotate said first and second crusher wheels;
h) wherein, said feeder chute is positioned to deliver an aluminum can between said first and second crusher wheels in order to crush the can between the rims of said first and second crusher wheels.

2. The electric aluminum can crusher according to claim 1, wherein said first and second crusher wheels are disposed within said housing.

3. The electric aluminum can crusher according to claim 1, wherein said first and second crusher wheels are made from hard rubber.

4. The electric aluminum can crusher according to claim 1, wherein said first and second crusher wheels each further comprise a plurality of grooves defined transversely across the rim of each said wheel, said grooves being adapted for engaging a lip of an aluminum can.

5. The electric aluminum can crusher according to claim 1, wherein said support arm is pivotally mounted to said housing.

6. The electric aluminum can crusher according to claim 5, further comprising a bias spring connected between said first and second crusher wheels, said bias spring normally biasing said support arm so that said second crusher wheel is adjacent to said first crusher wheel in order to crush an aluminum can between said wheels, said support arm being pivotable away from said first crusher wheel in order to clear a jam between said wheels.

7. The electric aluminum can crusher according to claim 1, wherein said housing has an opening defined therein, the opening being sized and dimensioned for permitting the passage of an aluminum can crushed along a peripheral wall of the can.

8. The electric aluminum can crusher according to claim 7, further comprising a discharge chute disposed between said crusher wheels and said opening.

9. The electric aluminum can crusher according to claim 1, further comprising a first retainer wall and a second retainer wall, said retainer walls being disposed in parallel on opposite sides of said first and second crusher wheels, said retainer walls being adapted for preventing lateral movement of an aluminum can as the can is drawn and crushed between said wheels.

10. The electric aluminum can crusher according to claim 1, wherein said actuator means comprises a sensor mechanism disposed inside said feeder chute for sensing the passage of an aluminum can through said feeder chute, said sensor mechanism applying electrical power to said motor for a predetermined period of time in order to crush the can.

11. The electric aluminum can crusher according to claim 11, wherein said sensor mechanism comprises an optoelectronic device.

12. The electric aluminum can crusher according to claim 11, wherein said sensor mechanism comprises an infrared transmitter and receiver.

13. The electric aluminum can crusher according to claim 1, wherein said second crusher wheel has a notch defined therein extending transversely across the rim of said wheel for engaging a lip of an aluminum can and drawing the can between said first crusher wheel and said second crusher wheel.

14. The electric aluminum can crusher according to claim 1, wherein said first crusher wheel and said second crusher wheel are driven to rotate in opposite directions by said chain drive mechanism.

15. The electric aluminum can crusher according to claim 1, wherein said chain drive mechanism comprises:
(a) an electric motor having a shaft;
(b) a drive sprocket mounted on the shaft of said motor;
(c) a first axle;
(d) a first roller sprocket mounted on said first axle, said first crusher wheel being coaxially mounted on said first axle and spaced apart from said first roller sprocket;
(e) a second axle rotatably mounted on said support arm;
(f) a second roller sprocket mounted on said second axle, said second crusher wheel being coaxially mounted on said second axle and spaced apart from said second roller sprocket; and
(g) a chain formed into a continuous loop connecting said drive sprocket, said first roller sprocket, and said second roller sprocket, whereby rotation of the shaft of said motor drives said first and second crusher wheels to rotate.

16. The electric aluminum can crusher according to claim 15, wherein said chain drive mechanism further comprises a tension sprocket connected to said chain, said second roller sprocket being disposed within the continuous loop defined by said chain and said first roller sprocket being disposed outside said loop, said tension sprocket maintaining sufficient tension on said chain in order to engage said first roller sprocket in said chain so that said first and second crusher wheels rotate in opposite directions.
